(19) United States
(12) Patent Application Publication
(10) Pub. No.: US 2024/0202460 A1
(43) Pub. Date: Jun. 20, 2024

(54) INTERFACING WITH A SKILL STORE

(71) Applicant: Microsoft Technology Licensing, LLC, Redmond, WA (US)

(72) Inventors: Samuel Edward SCHILLACE, Portola Valley, CA (US); Umesh MADAN, Bellevue, WA (US)

(73) Assignee: Microsoft Technology Licensing, LLC, Redmond, WA (US)

(21) Appl. No.: 18/129,783

(22) Filed: Mar. 31, 2023

Related U.S. Application Data
(60) Provisional application No. 63/448,940, filed on Feb. 28, 2023.
(60) Provisional application No. 63/433,619, filed on Dec. 19, 2022.
(60) Provisional application No. 63/433,627, filed on Dec. 19, 2022.

(51) Int. Cl. G06F 40/40

(52) U.S. Cl. CPC G06F 40/40

(57) ABSTRACT

Systems and methods for interfacing with a skill store are provided herein. In some examples, a task is processed, using a generate large model (GLM) to orchestrate skills for performing the task. The orchestrated skills include a plurality of skills related to the task. At least one skill in the orchestrated skills is determined to not be available to the GLM, and an indication corresponding to the at least one skill is transmitted to a remote skill store. The indication may be associated with descriptions of the at least one skill, based on which similarities may be determined for retrieving skills from the remote skill store. A remote skill is received from the remote skill score that corresponds to the transmitted indication, and the task is performed using the generative LLM. The generative LLM uses the remote skill to perform the task.

### CROSS-REFERENCE TO RELATED APPLICATIONS

This application claims priority to U.S. Provisional Application No. 63/448,940, titled “Interfacing with a Skill Store,” filed on Feb. 28, 2023, U.S. Provisional Application No. 63/433,619, titled “Storing Entries in and Retrieving information From an Embedding Object Memory,” filed on Dec. 19, 2022, and U.S. Provisional Application No. 63/433,627, titled “Multi-Stage Machine Learning Model Chaining,” filed on Dec. 19, 2022, the entire disclosures of which are hereby incorporated by reference in their entirety.

### BACKGROUND

Computing devices may be relied on to perform any of a variety of different tasks. Some of the different tasks may be executed using skills. Further, some of the different tasks may be executed using automated systems. However, if skills that are necessary for performing a task are not available, such an occurrence may result in a diminished user experience, increased user frustration, and/or wasted computational resources, among other detriments.

It is with respect to these and other general considerations that aspects of the present disclosure have been described. Also, although relatively specific problems have been discussed, it should be understood that the aspects disclosed herein should not be limited to solving the specific problems identified in the background.

### SUMMARY

Aspects of the present disclosure relate to methods, systems, and media for interfacing with a skill store, such as using a generative large language model (GLLM), or a generative large model (GLM). Exemplary systems and methods for interfacing with a skill store are provided herein. In some examples, a task is processed, using a generate large model (GLM) to orchestrate skills for performing the task. The orchestrated skills include a plurality of skills related to the task. At least one skill in the orchestrated skills is determined to not be available to the GLM, and an indication corresponding to the at least one skill is transmitted to a remote skill store. The indication may be associated with descriptions of the at least one skill, based on which similarities may be determined for retrieving skills from the remote skill store. A remote skill is received from the remote skill score that corresponds to the transmitted indication, and the task is performed using the generative LLM. The generative LLM uses the remote skill to perform the task.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates examples of content, such as private content and public content, according to some aspects described herein.

FIG. 3 illustrates an example vector space, according to some aspects described herein.

FIG. 4 illustrates an example flow for interfacing with a skill store, according to some aspects described herein.

FIG. 5 illustrates an example method for interfacing with a skill store, according to some aspects described herein.

FIG. 6 illustrates an example method for interfacing with a skill store, according to some aspects described herein.

FIGS. 7A and 7B illustrate overviews of an example generative machine learning model that may be used according to aspects described herein.

FIG. 8 illustrates a block diagram illustrating example physical components of a computing device with which aspects of the disclosure may be practiced.

FIG. 9 illustrates a simplified block diagrams of a computing device with which aspects of the present disclosure may be practiced.

FIG. 10 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As mentioned above, computing devices may be relied on to perform any of a variety of different tasks. Some of the different tasks may be executed using skills. Further, some of the different tasks may be executed using automated systems, such as models that are trained using artificial intelligence (AI) or machine learning (ML). However, if skills that are necessary for performing a task are not available, such an occurrence may result in a diminished user experience, increased user frustration, and/or wasted computational resources, among other detriments.

The present disclosure provides a skill store that may be used by an agent (e.g., a hardware and/or software component) designed to extend the capabilities of the agent and build on the capabilities of a semantic kernel (SK). The skill store provided herein may be a marketplace for skills that allows discovery by agents, such as models that are trained using AI or ML, attempting to solve problems (e.g., tasks provided by systems and/or users). The store may be primarily accessible to AI agents, and may act as a global and/or centralized store that is findable with skills.

A task, problem or request may be processed to generate an orchestration of skills which execute operations to address the task, problem or request. The orchestration of skills may include a skill chain, script, code, a graph of operations, etc. When an SK (e.g., the SK local to a device) is unable to solve a portion of the orchestration of skills, such as a chain of skills (e.g., leaving one or more skills unsolved or unlocated on a device), the unsolved skill(s) can be sent to the skill store as an application programming interface (API) request. The skill store returns one or more skills that may solve the problem, such as via comparisons or rankings based on vector or semantic embeddings of parameters corresponding to the one or more skills. The lookup and execution of skills can be transparent to a user. The store may return not just a single skill (e.g., a perfect hit, a highest ranking), but may find likely candidates, such as based on confidence scores associated with results, and do refinement (e.g., interrogatory, introspection) to improve a precision of determining a skill. Skills discussed herein may reference other models, parameters, source code locations, and methods for solving the problems.

In some examples, an SK receives a query. The SK may break the query into components (e.g., skills, parameters) for execution or orchestration (e.g., chaining). Mechanisms provided herein may determine that local skills do not apply to one or more aspects of an orchestration of skills (e.g., chain steps), therefore requiring the mechanisms to interface with a remote skill store. The interface to the remote skill store may occur via an API such that the skill store receives a request based on semantic parameters (e.g., arguments) for a skill (e.g., recognize a cat in an image).

After the interface occurs via the API, the skill store may return one or more matching skills based on geometric distance, similarity, ranking, or some other computational comparison. The SK may choose the best skill from the one or more matching skills (e.g., based on an introspection, user-feedback, or some other evaluation). The SK may further obtain resources for the returned skill, such as, for example, a model, parameters, source location, how to call the skill, how to host the skill, how to parse return information, or other resources that may be recognized by those of ordinary skill in the art. The SK completes the previously unknown skills in the orchestration of skills (e.g., chain of skills), such that operations may be executed to address the processed task or problem. In some examples, it is possible to import and/or dynamically load skills into the SK from an external store for frequent use. In some examples, the skill store may be accessible locally, regionally, and/or globally.

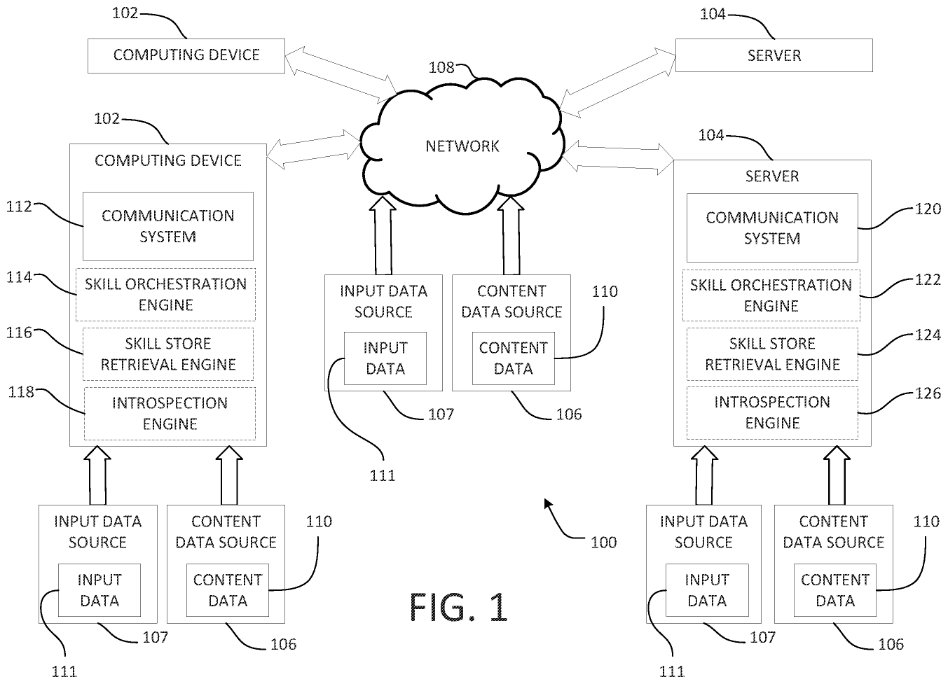

FIG. 1 shows an example of a system 100, in accordance with some aspects of the disclosed subject matter. The system 100 may be a system for interfacing with a skill store. Additionally, or alternatively, the system 100 may be a system for interfacing with a skill store using a generative large model (GLM), such as a generative large language model (LLM). The system 100 includes one or more computing devices 102, one or more servers 104, a content data source 106, an input data source 107, and a communication network or network 108.

The computing device 102 can receive content data 110 from the content data source 106, which may be, for example a microphone, a camera, a global positioning system (GPS), etc. that transmits content data, a computer-executed program that generates content data, and/or memory with data stored therein corresponding to content data. The content data 110 may include visual content data, audio content data (e.g., speech or ambient noise), gaze content data, calendar entries, emails, document data (e.g., a virtual document), weather data, news data, blog data, encyclopedia data and/or other types of private and/or public content data that may be recognized by those of ordinary skill in the art. In some examples, the content data may include text, source code, commands, skills, or programmatic evaluations.

The computing device 102 can further receive input data 111 from the input data source 107, which may be, for example, a camera, a microphone, a computer-executed program that generates input data, and/or memory with data stored therein corresponding to input data. The content data 111 may be, for example, a user-input, such as a voice query, text query, etc., an image, an action performed by a user and/or a device, a computer command, a programmatic evaluation, or some other input data that may be recognized by those of ordinary skill in the art.

Additionally, or alternatively, the network 108 can receive content data 110 from the content data source 106. Additionally, or alternatively, the network 108 can receive input data 111 from the input data source 107.

Computing device 102 may include a communication system 112, a skill orchestration engine or component 114, a skill store retrieval engine or component 116, and/or an introspection engine or component 118. In some examples, computing device 102 can execute at least a portion of the skill orchestration component 114 to orchestrate skills. The orchestrating of skills may include generating a chain of skills, script, code, a graph of operations, or the like for performing a task. For example, the orchestration of skills (e.g., chain of skills) may include a plurality of skills and/or one or more prompts that correspond to skills.

Further, in some examples, computing device 102 can execute at least a portion of the skill store retrieval component 116 to retrieve a skill from one or more skill stores. For example, the one or more skills stores may be private skill stores and/or public skill stores. In some examples, the skill stores may each be accessible by a different tenant (e.g., an organization, individual, etc.). In some examples, the one or more skill stores may be local to a computing device, such as the computing device 102. Additionally, and/or alternatively, in some examples, the one or more skills stores may be remote from the computing device 102, such as by being stored on a server (e.g., server 104).

Further, in some examples, computing device 102 can execute at least a portion of the introspection component 118 to question whether a functional agent (e.g., the GLM) knows how to perform a skill (e.g., from the chain of skills). For example, the introspection may include determining to a degree of confidence if mechanisms disclosed herein know how to perform a skill, know how to perform a skill correctly, etc. Additional and/or alternative types of introspection which may be used to evaluate the selection and/or performance of a skill may be recognized by those of ordinary skill in the art.

Server 104 may include a communication system 120, a skill orchestration engine or component 122, a skill store retrieval engine or component 124, and/or an introspection engine or component 126. In some examples, server 104 can execute at least a portion of the skill orchestration component 122 to orchestrate skills. The orchestrating of skills may include generating a chain of skills, script, code a graph of operations, or the like for performing a task. For example, the orchestration of skills (e.g., chain of skills) may include a plurality of skills and/or one or more prompts that correspond to skills.

Further, in some examples, server 104 can execute at least a portion of the skill store retrieval component 124 to retrieve a skill from one or more skill stores. For example, the one or more skills stores may be private skill stores and/or public skill stores. In some examples, the one or more skill stores may each be accessible by a different tenant (e.g., an organization, individual, etc.). In some examples, the one or more skill stores may be local to a client device, such as the computing device 102. Additionally, and/or alternatively, in some examples, the one or more skills stores may be remote from the client device, such as by being stored on a server (e.g., server 104).

Further, in some examples, server 104 can execute at least a portion of the introspection component 126 to question whether a functional agent (e.g., the GLM, another model, and/or software or hardware components described herein) knows how to perform a skill (e.g., from the chain of skills). For example, the introspection may include determining to a degree of confidence if mechanisms disclosed herein know how to perform a skill, know how to perform a skill correctly, etc. Additional and/or alternative types of introspection which may be used to evaluate the selection and/or performance of a skill may be recognized by those of ordinary skill in the art.

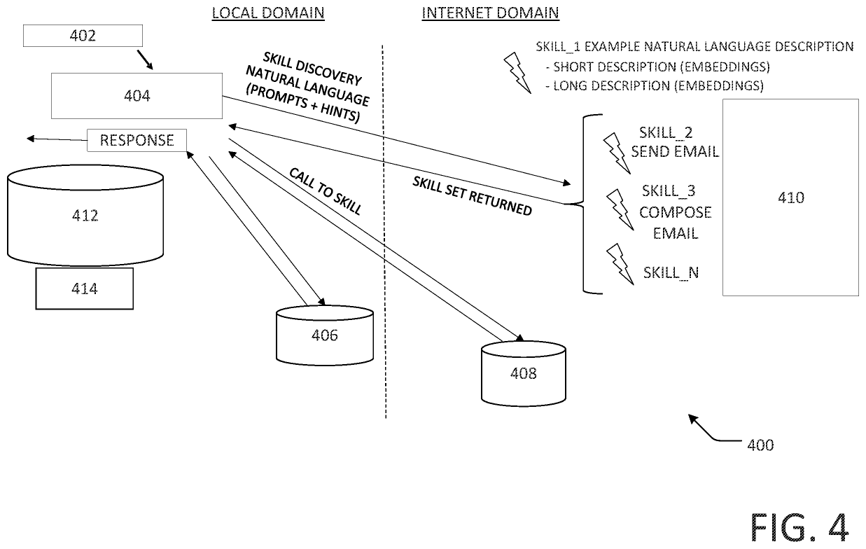

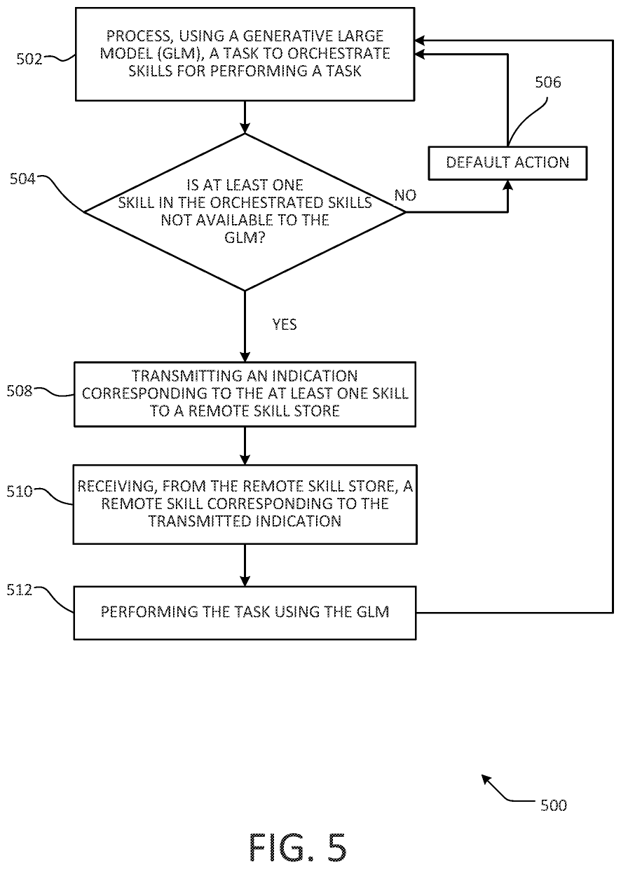

Additionally, or alternatively, in some examples, computing device 102 can communicate data received from content data source 106 and/or input data source 107 to the server 104 over a communication network 108, which can execute at least a portion of the skill orchestration component 114, skill store retrieval component 116, and/or introspection component 118. In some examples, the skill orchestration component 114 may execute one or more portions of methods/processes 400 and/or 500 described below in connection with FIGS. 4 and 5, respectively. Further in some examples, the skill store retrieval component may execute one or more portions of methods/processes 400 and/or 500 described below in connection with FIGS. 4 and 5, respectively. Still further, in some examples, the introspection component may execute one or more portions of methods/processes 400 and/or 500 described below in connection with FIGS. 4 and 5.

In some examples, computing device 102 and/or server 104 can be any suitable computing device or combination of devices, such as a desktop computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing devices 102 and/or a plurality of servers 104. It should be recognized by those of ordinary skill in the art that content data 110 and/or input data 111 may be received at one or more of the plurality of computing devices 102 and/or one or more of the plurality of servers 104, such that mechanisms described herein can interface with a skill store, based on an aggregation of content data 110 and/or input data 111 that is received across the computing devices 102 and/or the servers 104.

In some examples, content data source 106 can be any suitable source of content data (e.g., a microphone, a camera, a GPS, a sensor, etc.). In a more particular example, content data source 106 can include memory storing content data (e.g., local memory of computing device 102, local memory of server 104, cloud storage, portable memory connected to computing device 102, portable memory connected to server 104, etc.). In another more particular example, content data source 106 can include an application configured to generate content data. In some examples, content data source 106 can be local to computing device 102. Additionally, or alternatively, content data source 106 can be remote from computing device 102 and can communicate content data 110 to computing device 102 (and/or server 104) via a communication network (e.g., communication network 108).

In some examples, input data source 107 can be any suitable source of input data (e.g., a microphone, a camera, a sensor, etc.). In a more particular example, input data source 107 can include memory storing input data (e.g., local memory of computing device 102, local memory of server 104, cloud storage, portable memory connected to computing device 102, portable memory connected to server 104, privately-accessible memory, publicly-accessible memory, etc.). In another more particular example, input data source 107 can include an application configured to generate input data. In some examples, input data source 107 can be local to computing device 102. Additionally, or alternatively, input data source 107 can be remote from computing device 102 and can communicate input data 111 to computing device 102 (and/or server 104) via a communication network (e.g., communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

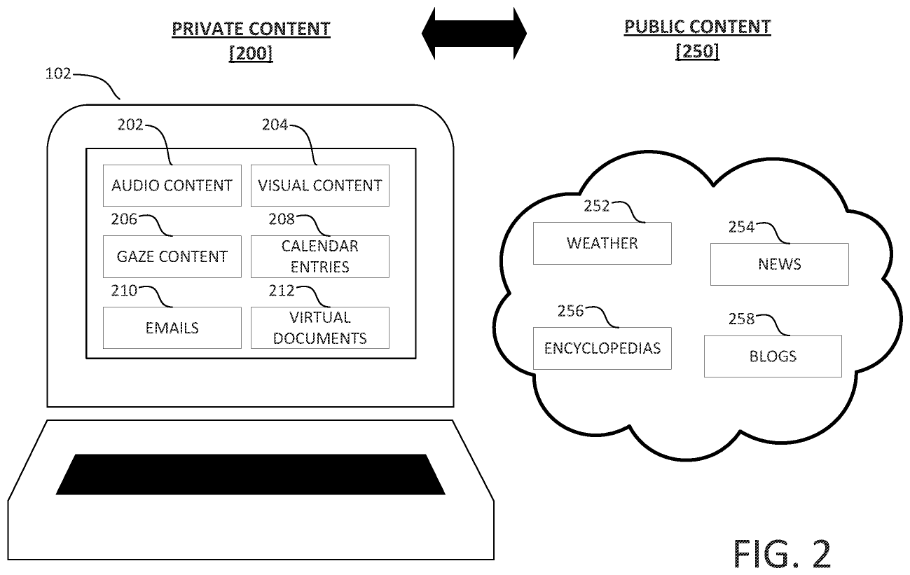

FIG. 2 illustrates examples of content, such as private content 200 and public content 250, according to some aspects described herein. As discussed with respect to system 100, examples described may receive content data (e.g., content data 110) from a content data source (e.g., content data source 106). The content data that is received may include the private content 200 and/or public content 250. Additionally, or alternatively, the content data may include source code, commands, programmatic evaluations, or skills. The content illustrated in FIG. 2 may provide context to a model and/or a skill store regarding which skills are intended to be retrieved and/or performed to accomplish an intended task. Namely, the content may help to precisely define aspects of the intended task and/or corresponding skills related thereto.

Generally, when a user is interacting with a computing device (e.g., computing device 102), they may be interacting with applications that are stored locally on the computing device and/or that can be executed locally on the computing device. Information that a user accesses or executes locally on their device may include the private content 200.

The private content includes audio content 202, visual content 204, gaze content 206, calendar entries 208, emails 210, and documents 212, as examples. Additional and/or alternative types of private content may be recognized by those of ordinary skill in the art.

The audio content 202 may include data corresponding to speech data that is generated. For example, the audio content 202 may be generated by the computing device 102 to correspond to audio that is received from a user (e.g., where the user is speaking into a microphone a computing device that may be separate from the computing device 102). Additionally, or alternatively, the audio content 202 may correspond to types of audio data that may be generated by a computing device, such as synthetic speech, animal sounds, beeps, buzzes, or another type of generated audio data.

The visual content 204 may include data corresponding to graphical content that may be displayed and/or generated by a computing device. For example, the visual content 204 may be content that is generated via an application being run on the computing device 102 (e.g., a web-browser, a presentation application, a teleconferencing application, a business management application, etc.). The visual content 204 may include data that is scraped from a screen display of the computing device 102. For example, any visual indication that is displayed on the computing device 102 may be included in the visual content 204.

The gaze content 206 may include data corresponding to where users are looking. For example, specific actions to be performed by a computing device may be associated with a specific location at which a user is looking and/or a combination of locations at which a user is looking within a predefined duration of time.

The calendar entries 208 may include calendar data specific to one or more users. For example, the calendar data may include meetings, appointments, reservations or other types of calendar entries. Additionally, or alternatively, the calendar data may include times, locations, attendees, and/or notes regarding specific calendar entries. Additional and/or alternative data associated with calendar entries may be recognized by those of ordinary skill in the art.

The emails 210 may include email data for one or more emails. For example, the emails 210 may include email data corresponding to a collection or plurality of emails. The email data may include senders and recipients, subjects, messages, images, timestamps, and/or other types of information that may be associated with emails. Additional and/or alternative data associated with calendar entries may be recognized by those of ordinary skill in the art.

The virtual documents 212 may include a type of document that is found in a virtual environment. For example, the virtual document 212 may be a text-editing document, a presentation, an image, a spreadsheet, an animated series of images, a notification, or any other type of virtual document that may be recognized by those of ordinary skill in the art.

Each of the plurality of types of private content 200 may be subsets of the private content 200 that may be received by mechanisms described herein, as a subset of the content data 110. Further, while specific examples of types of private content have been discussed above, additional and/or alternative types of private content may be recognized by those of ordinary skill in the art.

The public content 250 includes weather 252, news 254, encyclopedias 256, blogs 258 and the like. The weather 252 may include information regarding weather that is around a user and/or at a location determined to be of interest for a user. For example, for a given time, weather information (e.g., precipitation, temperature, humidity, etc.) may be received or otherwise obtained for where a user is located (e.g., based on location content) and/or a location determined to be of interest to the user.

The news 254 may include information regarding recent news stories that are determined to be of interest to a user. For example, for a given time, a relatively recent news story covering a significant event may have been released. Additional or alternative types of news stories may include holidays, birthdays, local events, national events, natural disasters, celebrity updates, scientific discoveries, sports updates, or any other type of news that may be recognized by those of ordinary skill in the art.

The encyclopedia 256 may include publicly available encyclopedia information. For example, the encyclopedia 256 may include information from an online database of encyclopedic information. Additionally, or alternatively, the encyclopedia 256 may include pages from an online encyclopedia website. Additional or alternative types of encyclopedia information may be recognized by those of ordinary skill in the art.

The blogs 256 may include information from blogs. For example, the blogs may include publicly available posts from users of a blog website and/or a social media platform. The blogs may be posted by, for example, famous people, such as chefs, politicians, actors, etc. Alternatively, the blogs may be posted by other users who post content online that may be publicly accessible by mechanisms disclosed herein.

Generally, the different content types discussed with respect to FIG. 2 provide various types of content that may be received or otherwise accessed by a computing device and that may be useful in providing contextual information for determining skills described herein. Further, while specific subsets of content were described above with respect to one of the private content 200 and the public content 250, it should be recognized that in some examples the subsets of content may instead be described with respect to the other of the private content 200 or the public content 250. Further, it is noted that additional and/or alternative types of private content 200 and/or public content 250 will be recognized by those of ordinary skill in the art.

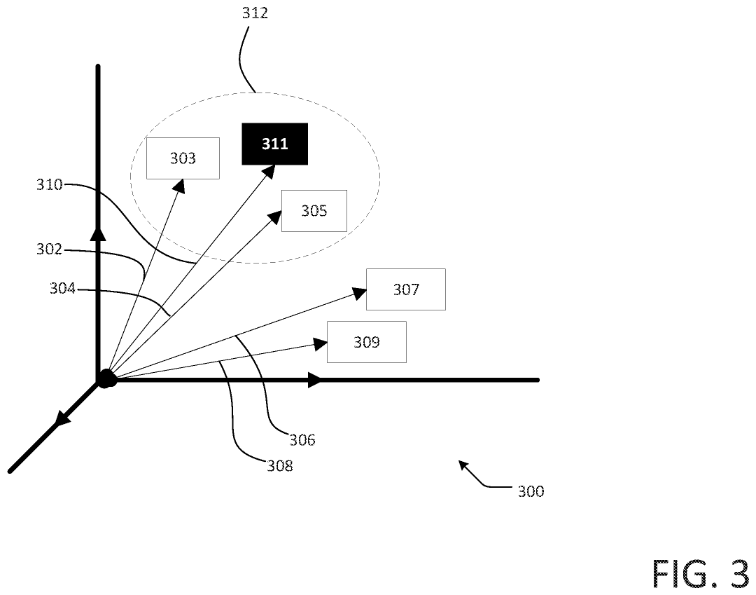

FIG. 3 illustrates an example vector space 300 according to some aspects described herein. The vector space 300 includes a plurality of feature vectors, such as a first feature vector 302, a second feature vector 304, a third feature vector 306, a fourth feature vector 308, and a fifth feature vector 310. Each of the plurality of feature vectors 302, 304, 306, and 308 correspond to a respective embedding 303, 305, 307, 309 generated based on a plurality of skills and/or a plurality of subsets of content data (e.g., subsets of content data 110, private content 200, and/or public content 250). The embeddings 303, 305, 307, and 309 may be semantic embeddings. The fifth feature vector 310 is generated based on an input embedding 311. The input embedding may be generated based on an input (e.g., input data 111). For example, the input may be user-input corresponding to a task that is desired to be performed.

The feature vectors 302, 304, 306, 308, 310 each have distances that are measurable between each other. For example, a distance between the feature vectors 302, 304, 306, and 308 and the fifth feature vector 310 corresponding to the input embedding 311 may be measured using cosine similarity. Alternatively, a distance between the feature vectors 302, 304, 306, 308 and the fifth feature vector 310 may be measured using another distance measuring technique (e.g., an n-dimensional distance function) that may be recognized by those of ordinary skill in the art.

A similarity of each of the feature vectors 302, 304, 306, 308 to the feature vector 310 corresponding to the input embedding 311 may be determined, for example based on the measured distances between the feature vectors 302, 304, 306, 308 and the feature vector 310. The similarity between the feature vectors 302, 304, 306, 308 and the feature vector 310 may be used to group or cluster the feature vectors 302, 304, 306, and 308 in one or more collections of feature vectors, such as a collection 312, thereby generating a collection of embeddings.

In some examples, the collection 312 may include a predetermined number of feature vectors, such that groups of feature vectors are given a predetermined size. Additionally, or alternatively, in some examples, The distances between each of the feature vectors 302, 304, 306, 308 and the feature vector 310 corresponding to the input embedding 311 may be compared to a predetermined threshold.

The embeddings 303 and 305 that correspond to feature vectors 302 and 304, respectively, may fall within the same content group and/or a same category of skills. For example, the embedding 303 may be related to a skill for sending an email using a first email protocol, and the embedding 305 may be related to a skill for sending an email using a second email protocol. Additional and/or alternative examples of content groups and/or skill categories in which the embeddings may be categorized may be recognized by those of ordinary skill in the art.

The collection 312 may be stored in a data structure, such as an ANN tree, a k-d tree, an octree, another n-dimensional tree, or another data structure that may be recognized by those of ordinary skill in the art that is capable of storing vector space representations. Further, memory corresponding to the data structure in which the collection 312 is stored may be arranged or stored in a manner that groups the embeddings and/or vectors in the collection 312 together, within the data structure. In some examples, feature vectors and their corresponding embeddings generated in accordance with mechanisms described herein may be stored for an indefinite period of time. Additionally, or alternatively, in some examples, as new feature vectors and/or embeddings are generated and stored, the new feature vectors and/or embeddings may overwrite older feature vectors and/or embeddings that are stored in memory (e.g., based on metadata of the embeddings indicating a version), such as to improve memory capacity. Additionally, or alternatively, in some examples, feature vectors and/or embeddings may be deleted from memory at specified intervals of time, and/or based on an amount of memory that is available (e.g., in one or more skill stores described herein), to improve memory capacity.

Generally, the ability to store embeddings corresponding to received content data and/or stored skills allows a user to associate and locate data in a novel manner that has the benefit of being computationally efficient. Therefore, the mechanisms described herein are efficient for reducing memory usage, as well as for reducing usage of processing resources to search through stored content and/or skills. Additional and/or alternative advantages may be recognized by those of ordinary skill in the art.

FIG. 4 illustrates an example flow 400 for interfacing with a skill store 410, according to some aspects described herein. In some examples, a user request 402 is received. At orchestrator 404, the user request 402 may be processed to orchestrate skills for performing a task. For example, the orchestrated skills may include a chain of skills, script, code, a graph of operations, etc.

The orchestrator 404 may interface with a self-skill model 406, a third-party skill model 408, and/or a skill store 408, such as via a generative large model (GLM). For example, the orchestrator 404 may perform skill discovery to locate one or more skills, such as based on prompts or hints. The prompts or hints may be in the form of natural language and/or an intermediate language from which at least a portion of a user's intent from the request 402 can be derived.

The user request 402, the orchestrator 404, and/or the self-skill model 406 may be stored, accessed, and/or executed on a local domain. The self-skill model 406 may include a plurality of skills that are specific to the user who provided the request 402 and/or that are accessible only to users permitted access to the local domain.

The third-party skill model 408 and/or the skill store 410 may be stored, accessed, and/or executed on an internet domain. The third-party skill store may include a plurality of skills that are specific to an organization (e.g., a third-party organization that manages skills for specific tasks) and/or that are accessible to users who are permitted access to services provided by a third-party responsible for the third-party skill store 408 in the internet domain. The skill store 410 may be an artificial intelligence (AI) and/or machine-learning (ML) vector skill store. In some examples, the skill store 410 is a graph, or a database, or another data structure which will be recognized by those of ordinary skill in the art as capable of storing skills and interfacing with mechanisms described herein.

The skill store 410 may be implemented using tenant segregation. The skill store 410 may have sharing rules that permit certain skills to be accessible by certain individuals and/or prohibit certain skills from being accessible to certain individuals. In some examples, the skill store 410 is a plurality of skill stores that together form the skill store 410. In some examples, skills may be uploaded to, updated within, and/or removed from the skill store 410. In some examples, the skills that are uploaded to the skill store 410 need to be verified and/or checked for malware, such as via a signing mechanisms.

In some examples, skills within the skill store 410, or executed by the self-skill model 406 and/or third-party skill model 408, can have descriptions, such as short descriptions and/or long descriptions to help to identify the skills. The descriptions may include natural language and/or intermediary language. In some examples, the descriptions may be embeddings used for semantic similarity matching.

In some examples, a local semantic kernel (SK) 412 determines if skills returned from one of the self-skill model 406, third-party skill model 408, and/or skill store 410 are suitable. In some examples, the SK 412 asks a user for feedback regarding the returned skills and/or returns a confidence score with respect to a probability that the returned skills will perform a task to accomplish at least a portion of the user request 402. The SK may include memory and local skills that are executable based on contents stored within the memory.

In some examples, if suitable skills cannot be found, skills can be generated, such as based on a description of the skill that cannot be found. In some examples, the SK calls skills that are orchestrated by the orchestrator 404 and/or calls skill models, such as the self-skill model 406 and/or the third-party skill model 408 to complete the skills.

In some examples, results from skills executed by a plurality of different SKs 412 can be combined and a single result can be returned. In some examples, the SK 412 can have hard-coded logic for chunking inputs and/or outputs, such as inputs for executing certain skills and/or outputs provided as a result of executing certain skills.

In some examples, the SK may be associated with a store directory 414. The store directory may include one or more default skill stores and/or custom preferences for retrieving and/or executing skills.

FIG. 5 illustrates an example method 500 for interfacing with a skill store, according to some aspects described herein. In examples, aspects of method 500 are performed by a device, such as computing device 102 and/or server 104, discussed above with respect to FIG. 1.

Method 500 begins at operation 502, wherein a task is processed to orchestrate skills (e.g., generate a chain of skills) for performing the task. The task may be processed using a model, such as a generative large model (GLM). In some examples, the GLM may be a generative large language model (LLM). In some examples, the model may be another type of machine learning model as will be recognized by those of ordinary skill in the art.

The task may be received as, or generated based on, input (e.g., input data 111). The orchestrated skills (e.g., chain of skills) may include a plurality of skills related to the task. Additionally, or alternatively, the orchestrated skills (e.g., chain of skills) may include a plurality of indications corresponds to skills related to the task, such as descriptions, prompts, parameters, variables, etc.

To orchestrate skills (e.g., generate a skill chain), an orchestration prompt may be generated by a chain orchestrator, which can include an indication of one or more skills from a skill library or store or listing and at least a part of an input, such that the generative LLM model orchestrates skills (e.g., generates a skill chain) with which user input is processed. Thus, the chain orchestrator may map one or more intents of the input to one or more model and/or programmatic skills of the skill library accordingly.

Orchestrated skills (e.g., a skill chain) may include one or more sequential skills, a hierarchical set of skills, a set of parallel skills, and/or a skill that is dependent on or otherwise processes output from two or more prior skills, among other examples. In examples, the evaluation order of the orchestrated skills is determined based on the available skills of a skill store. Additionally, or alternatively, the orchestrated skills include one or more programmatic skills, code, machine instructions, prompts, hints, or the like. In some examples, a context may be provided to the model when orchestrating the skills, such as generating the skill chain, (e.g., which may be included as part of the generated prompt), as may be determined by a recall engine from a semantic memory engine.

At operation 504, it is determined if there is at least one skill in the orchestrated skills (e.g., chain of skills) that is not available to the generative LLM. For example, the determining that at least one skill in the orchestrated skills is not available to a generative LLM may include determining that at least one skill in the chain of skills does not correspond to one or more local skills stored on a local device.

In some examples, one or more skills of the orchestrated skills are stored on a local device. The one or more skills stored on the local device may be stored in a public skill store and/or a private skill store. A private skill store may have access that is restricted to a specific set of users and/or organizations. For example, the private skill store may have permissions that exclude certain users and/or systems from accessing skills in the private skill store. In some examples, the public skill store may have no restrictions regarding access. Alternatively, the public skill store may have access restrictions that are more relaxed than the private skill store (e.g., allowing a relatively greater amount of access thereto than the private skill store).

In some examples, there may be a plurality of skill stores located local to and/or remote from a client device. The plurality of skill stores may have tenant segregation that limit which users and/or organizations are able to access each of the skills stores. Additional and/or alternative security protocols that control access and/or maintenance of the skill stores described herein may be recognized by those of ordinary skill in the art.

If it is determined that all of the skills in the orchestrated skills are available to the generative LLM (e.g., there is not at least one skills in the orchestrated skills that is unavailable to the generative LLM), flow branches “NO” to operation 506, where a default action is performed. For example, the orchestrated skills (e.g., generated chain of skills) may have an associated pre-configured action. In other examples, method 500 may comprise determining whether the orchestrated skills have an associated default action, such that, in some instances, no action may be performed as a result of orchestrating the skills. Method 500 may terminate at operation 506. Alternatively, method 500 may return to operation 502 to provide an iterative loop of processing a task to orchestrate skills and determining if at least one skill in the orchestrated skills is not available to the generative LLM.

If however, it is determined that there is at least one skill in the orchestrated skills that is not available to the generative LLM, flow instead branches “YES” to operation 508, where an indication corresponding to the at least one skills is transmitted to a remote skill store. The remote skill store may be stored on one or more remote devices, such as the server 104 described above with respect to FIG. 1.

In some examples, the transmitting an indication corresponding to the at least one skill to a remote skill store includes generating a description of the at least one skill. Further, in some examples, the indication corresponding to the at least one skill is transmitted to the remote skill store via an application programming interface (API).

At operation 510, a remote skill corresponding to the transmitted indication is received, such as from the remote skill store. In some examples, the receiving the remote skill includes receiving the remote skill based on the description of the at least one skill. In some examples, the description is a short description. Further, in some examples, the transmitting an indication corresponding to the at least one skill to a remote skill store further comprises generating a long description of the at least one skill (e.g., via the generative LLM). The receiving the remote skill may include receiving the remote skill based on the generated long description and the generated short description of the at least one skill.

Generally, providing a short description may provide a quick way to locate a skill within a skill store. However, by providing a long description (e.g., a description that is more detailed than the short description), a skill may be located within a skill store with relatively more precision. Therefore, one of ordinary skill should recognize that by continuing to increase the length and/or detail of a description corresponding a skill, mechanisms described herein may be able to increase a degree of precision with which a desired skill may be located to perform the processed task of operation 502.

In some examples, the generated descriptions (e.g., long description and/or short description) are natural language. In some examples, the generated descriptions are an intermediate language, such as a programming language or a representation that is used as an intermediate step in the compilation or interpretation process of a high-level language. In some examples, the generated descriptions are embeddings, such as embeddings that are generated by a model (e.g., based on visual processing and/or natural language processing).

In some examples, the receiving a remote skill includes performing an introspection on the remote skill, based on the description, to generate a confidence threshold corresponding to the remote skill and the task. For example, if a user requests, directly or indirectly (e.g., as part of a larger task), to send an email using a specific application, but the skill store does not know how to send an email using the specification application, then the skill store may instead evaluate how to send an email using an application that has a similar protocol as the specific application. Accordingly, one or more remote skills may be evaluated and assigned a confidence score corresponding to how likely the one or more remote skills satisfy an intent of the user. The intent of the user may be clarified, such as using content information (see FIG. 2) that provide semantic context to the intent of a user's request. Additional and/or alternative examples may be recognized by those of ordinary skill in the art.

In some examples, skills in the skill store, such as the received remote skill, may be associated with models, parameters, source locations, how to call the skill, how to host the skill, and how to parse return information, and/or other information that may be recognized by those of ordinary skill in the art.

At operation 512, the task is performed, such as using the generative LLM. The generative LLM may use the received remote skill to perform the task. For example, the received remote skill may be used in parallel and/or in sequence to other skills (e.g., received from a local and/or remote skill store) to perform the task. In some examples, one or more skills of the plurality of skills (e.g., from the orchestrated skills) include machine-executable instructions. The performing the task may include adapting one or more devices to execute the machine-executable instructions. For example, the one or more devices may include a single device (e.g., computing device 102 and/or server 104), and/or a plurality of devices that each execute at least a portion of the machine-executable instructions.

In some examples, prior to performing the task at operation 512, the method 500 includes providing a notification to a user corresponding to the remote skill. For example, the notification may include an audio and/or visual report describing the remote skill. In response to the notification, feedback may be received (e.g., from the user) validating the remote skill. In such examples, the received remote skill may only be performed when validation feedback is received, prior to the task being performed.

Method 500 may terminate at operation 512. Alternatively, method 500 may return to operation 502 to provide an iterative loop of processing a task to orchestrate skills for performing the task, interfacing with a remote skill store, and performing the task using the generative LLM, by using (at least) a skill received from the remote skill store.

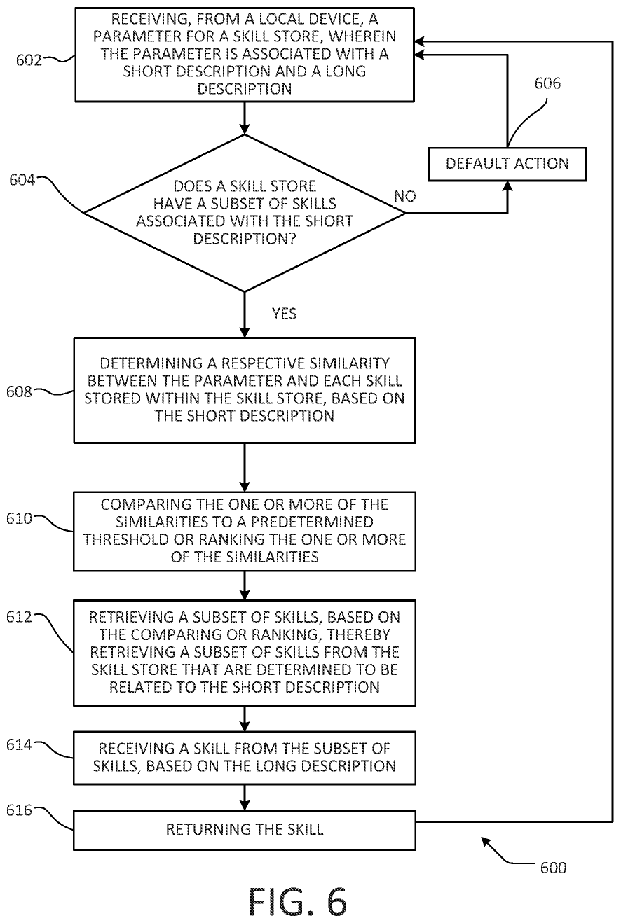

FIG. 6 illustrates an example method 600 for interfacing with a skill store, according to some aspects described herein. In examples, aspects of method 600 are performed by a device, such as computing device 102 and/or server 104, discussed above with respect to FIG. 1.

Method 600 begins at operation 602, wherein a parameter for a skill store is received from a local device. The parameter may be associated with one or more descriptions, such as a long description and/or a short description. The one or more descriptions (e.g., the short description, the long description) may each be natural language data or an embedding. For example, the descriptions may be natural language description written by a user and/or generative by a machine-learning model (e.g., generative LLM). In some examples, the descriptions are an intermediate language description, such as a programming language or a representation that is used as an intermediate step in the compilation or interpretation process of a high-level language. Additionally, or alternatively, the descriptions may be embeddings that are generated based on attributes or associations of the received parameter.

At operation 604, it is determined if a skill store has a subset of skills associated with at least one of the one or more descriptions. For example, it may be determined if the skill store has a subset of skills associated with the short description. Generally, it may be computationally efficient to search a skill store using a short description, as compared to a long description, such as because the short description provides fewer criteria on which to process a search. However, a relatively longer description may be helpful for improving accuracy of a search, such as by providing greater detail regarding one or more skills to be located within the skill store.

If it is determined that the skill store does not have a subset of skills associated with the short description, flow branches “NO” to operation 406, where a default action is performed. For example, the received parameter may have an associated pre-configured action. In other examples, method 400 may comprise determining whether the received parameter has an associated default action, such that, in some instances, no skill may be located within the skill store as a result of the received parameter. Method 600 may terminate at operation 606. Alternatively, method 600 may return to operation 602 to provide an iterative loop of receiving a parameter for a skill store and determining if the skill store has a subset of skills associated with a description with which the parameter is associated.

If however, it is determined that there is a subset of skills associated with the short description, flow instead branches “YES” to operation 608, where a respective similarity between the parameter and each skill (or one or more skills) stored within the skill store, based on the short description. In some examples, the similarity may be a semantic similarity. For example, the similarity may be based on abstract meaning behind elements being compared.

In some examples, the skill store includes a skill description, for one or more skills of the skills stored therein. The skill description may be generated by a model, such as by a generative LLM. Further, the respective similarity may be determined based at least in part on the skill description. For example, the skill description may be compared to the short description associated with the parameter. The skill description may include a natural language description. In some examples, the skills descriptions include an intermediate language, such as a programming language or a representation that is used as an intermediate step in the compilation or interpretation process of a high-level language. Additionally, or alternatively, the skill description may be an embedding.

At operation 610, the one or more of the similarities determined at operation 608 may be compared to a predetermined threshold. Additionally, or alternatively, the one or more similarities determined at operation 608 may be ranked. In some examples, at operation 610, the parameter may be matched with at least one skill within the skill store based on the determined semantic similarities from operation 608. In this regard, operation 610 may include performing semantic matching to determine which skills should be retrieved from the skill store.

At operation 612, a subset of skills are retrieved based on the comparing or ranking, thereby retrieving a subset of skills from the skill store that are determined to be related to the short description. In some examples, the subset of skills are retrieved based on the semantic matching. In some examples, the skill store may be one of a plurality of skills stores that are segregated by tenants, such that there is a separate skill store for each tenant (e.g., an individual, entity, organization). In some examples, there is one skill store that is restricted by tenants, such that, for example, certain skills within the skill store are only accessible to certain tenants.

In some examples, the skill store is one of a plurality of skills stores, and the plurality of skill stores include a private skill store and a public skill store. Accordingly, the skill store from which a subset of skills is received in operation 612 may be one of a public skill store or a private skill store. A private skill store may have access that is restricted to a specific set of users and/or organizations. For example, the private skill store may have permissions that exclude certain users and/or systems from accessing skills in the private skill store. In some examples, the public skill store may have no restrictions regarding access. Alternatively, the public skill store may have access restrictions that are more relaxed than the private skill store (e.g., allowing a relatively greater amount of access thereto than the private skill store).

In some examples, the skill store includes one or more of a vector representation, a hierarchical representation, or a graph of skills stored therein. When the skill store includes a vector representation of skills stored therein, the vector representation may be stored in at least one of an approximate nearest neighbor (ANN) tree, a k-d tree, an n-dimensional (e.g., multidimensional) tree, an octree, or another data structure that may be recognized by those of ordinary skill in the art in light of teachings described herein. Additional and/or alternative types of storage mechanisms that are capable of storing vector space representations may be recognized by those of ordinary skill in the art.

At operation 614, a skill is received from the subset of skills, based on the long description. For example, a respective similarity may be determined between the parameter and each skill of the subset of skills, based on the long description. Further, the predetermined threshold may be a first predetermined threshold, and operation 614 may further include comparing the one or more similarities between the parameter and each skill of the subset of skills to a second predetermined threshold. Additionally, or alternatively, the one or more similarities may be ranked. Operation 614 may further include retrieving the skill based on the comparing and/or ranking, thereby retrieving a skill from the subset of skills that is determined to be related to the long description.

At operation 616, the skill is returned. For example, the skill may be returned as an output to a user, a generative LLM, a system on which method 600 is being executed, and/or a system remote from that on which method 600 is being executed. Further, in some examples, the method 600 may further include adapting a computing device to perform an action based on the skill that is returned.

In some examples, new skills may be added to the skill store. A signing mechanism may be used to add new skills to the skill store. For example, a new skill may be received (e.g., at the computing device 102 and/or the server 104) to be stored in the skill store. The new skill may be received from a user and/or from a system. The new skill may be validated against a security protocol. For example, the security protocol may detect what actions are performed by the new skill, whether the skill includes malware, what resources are used to execute the new skill, what permission are required to execute the new skill, and/or other security validations that may be recognized by those of ordinary skill in the art. After the new skill is validated, the skill store may be updated to include the new skill.

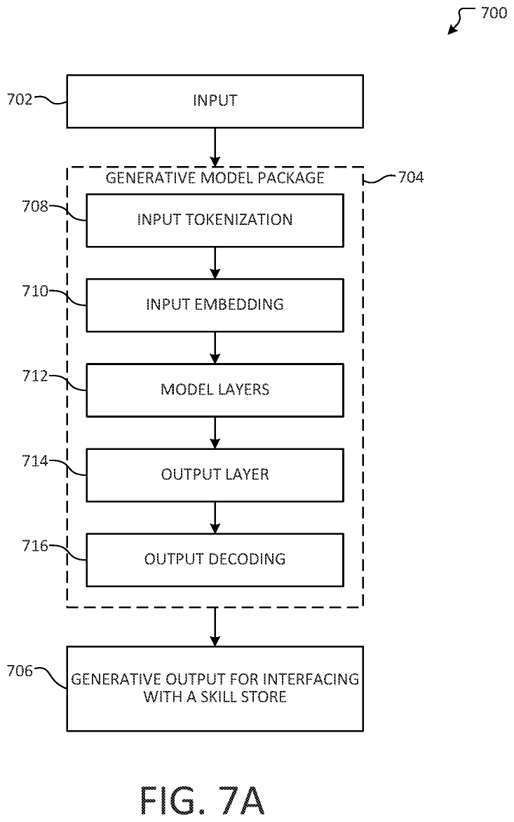

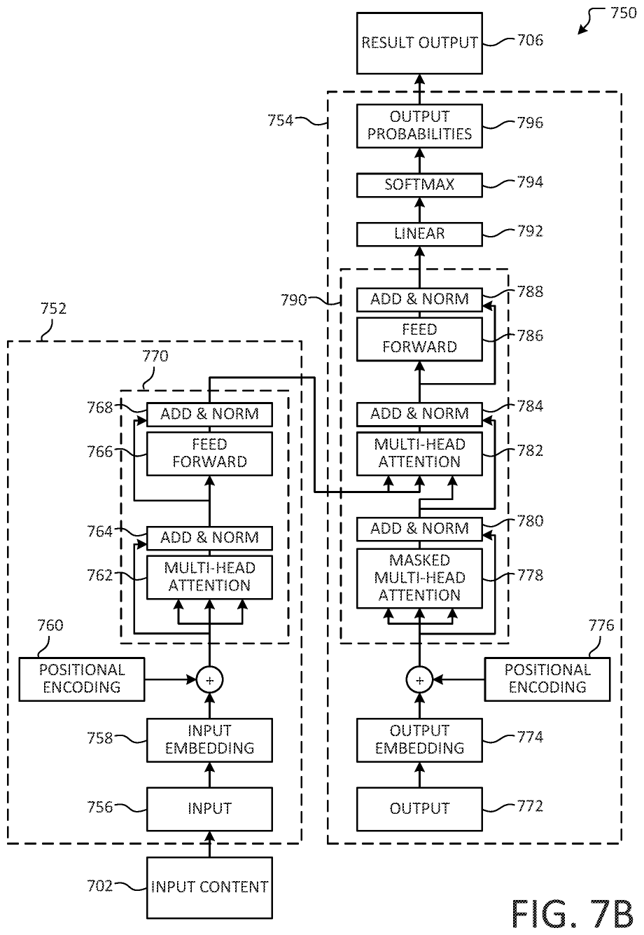

FIGS. 7A and 7B illustrate overviews of an example generative machine learning model that may be used according to aspects described herein. With reference first to FIG. 7A, conceptual diagram 700 depicts an overview of pre-trained generative model package 704 that processes an input 702 to generate model output for interfacing with a skill store 706 according to aspects described herein. Examples of pre-trained generative model package 704 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 704 is pre-trained according to a variety of inputs (e.g., a variety of human languages, a variety of programming languages, and/or a variety of content types) and therefore need not be finetuned or trained for a specific scenario. Rather, generative model package 704 may be more generally pre-trained, such that input 702 includes a prompt that is generated, selected, or otherwise engineered to induce generative model package 704 to produce certain generative model output 706. It will be appreciated that input 702 and generative model output 706 may each include any of a variety of content types, including, but not limited to, text output, image output, audio output, video output, programmatic output, and/or binary output, among other examples. In examples, input 702 and generative model output 706 may have different content types, as may be the case when generative model package 704 includes a generative multimodal machine learning model.

As such, generative model package 704 may be used in any of a variety of scenarios and, further, a different generative model package may be used in place of generative model package 704 without substantially modifying other associated aspects (e.g., similar to those described herein with respect to FIGS. 1-6). Accordingly, generative model package 704 operates as a tool with which machine learning processing is performed, in which certain inputs 702 to generative model package 704 are programmatically generated or otherwise determined, thereby causing generative model package 704 to produce model output 706 that may subsequently be used for further processing.

Generative model package 704 may be provided or otherwise used according to any of a variety of paradigms. For example, generative model package 704 may be used local to a computing device (e.g., computing device 102 in FIG. 1) or may be accessed remotely from a machine learning service. In other examples, aspects of generative model package 704 are distributed across multiple computing devices. In some instances, generative model package 704 is accessible via an application programming interface (API), as may be provided by an operating system of the computing device and/or by the machine learning service, among other examples.

With reference now to the illustrated aspects of generative model package 704, generative model package 704 includes input tokenization 708, input embedding 710, model layers 712, output layer 714, and output decoding 716. In examples, input tokenization 708 processes input 702 to generate input embedding 710, which includes a sequence of symbol representations that corresponds to input 702. Accordingly, input embedding 710 is processed by model layers 712, output layer 714, and output decoding 716 to produce model output 706. An example architecture corresponding to generative model package 704 is depicted in FIG. 7B, which is discussed below in further detail. Even so, it will be appreciated that the architectures that are illustrated and described herein are not to be taken in a limiting sense and, in other examples, any of a variety of other architectures may be used.

FIG. 7B is a conceptual diagram that depicts an example architecture 750 of a pre-trained generative machine learning model that may be used according to aspects described herein. As noted above, any of a variety of alternative architectures and corresponding ML models may be used in other examples without departing from the aspects described herein.

As illustrated, architecture 750 processes input 702 to produce generative model output 706, aspects of which were discussed above with respect to FIG. 7A. Architecture 750 is depicted as a transformer model that includes encoder 752 and decoder 754. Encoder 752 processes input embedding 758 (aspects of which may be similar to input embedding 710 in FIG. 7A), which includes a sequence of symbol representations that corresponds to input 756. In examples, input 756 includes input content 702 corresponding to a type of content, aspects of which may be similar to input data 111, private content 200, and/or public content 250.

Further, positional encoding 760 may introduce information about the relative and/or absolute position for tokens of input embedding 758. Similarly, output embedding 774 includes a sequence of symbol representations that correspond to output 772, while positional encoding 776 may similarly introduce information about the relative and/or absolute position for tokens of output embedding 774.

As illustrated, encoder 752 includes example layer 770. It will be appreciated that any number of such layers may be used, and that the depicted architecture is simplified for illustrative purposes. Example layer 770 includes two sub-layers: multi-head attention layer 762 and feed forward layer 766. In examples, a residual connection is included around each layer 762, 766, after which normalization layers 764 and 768, respectively, are included.

Decoder 754 includes example layer 790. Similar to encoder 752, any number of such layers may be used in other examples, and the depicted architecture of decoder 754 is simplified for illustrative purposes. As illustrated, example layer 790 includes three sub-layers: masked multi-head attention layer 778, multi-head attention layer 782, and feed forward layer 786. Aspects of multi-head attention layer 782 and feed forward layer 786 may be similar to those discussed above with respect to multi-head attention layer 762 and feed forward layer 766, respectively. Additionally, masked multi-head attention layer 778 performs multi-head attention over the output of encoder 752 (e.g., output 772). In examples, masked multi-head attention layer 778 prevents positions from attending to subsequent positions. Such masking, combined with offsetting the embeddings (e.g., by one position, as illustrated by multi-head attention layer 782), may ensure that a prediction for a given position depends on known output for one or more positions that are less than the given position. As illustrated, residual connections are also included around layers 778, 782, and 786, after which normalization layers 780, 784, and 788, respectively, are included.

Multi-head attention layers 762, 778, and 782 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 7B (e.g., by a corresponding normalization layer 764, 780, or 784).

Feed forward layers 766 and 786 may each be a fully connected feed-forward network, which applies to each position. In examples, feed forward layers 766 and 786 each include a plurality of linear transformations with a rectified linear unit activation in between. In examples, each linear transformation is the same across different positions, while different parameters may be used as compared to other linear transformations of the feed-forward network.

Additionally, aspects of linear transformation 792 may be similar to the linear transformations discussed above with respect to multi-head attention layers 762, 778, and 782, as well as feed forward layers 766 and 786. Softmax 794 may further convert the output of linear transformation 792 to predicted next-token probabilities, as indicated by output probabilities 796. It will be appreciated that the illustrated architecture is provided in as an example and, in other examples, any of a variety of other model architectures may be used in accordance with the disclosed aspects.

Accordingly, output probabilities 796 may thus form result output 706 according to aspects described herein, such that the output of the generative ML model (e.g., which may include structured output) is used as input for determining a skill according to aspects described herein (e.g., similar to a skill retrieved by the skill store retrieval component 116). In other examples, result output 706 is provided as generated output for interfacing with a skill store.

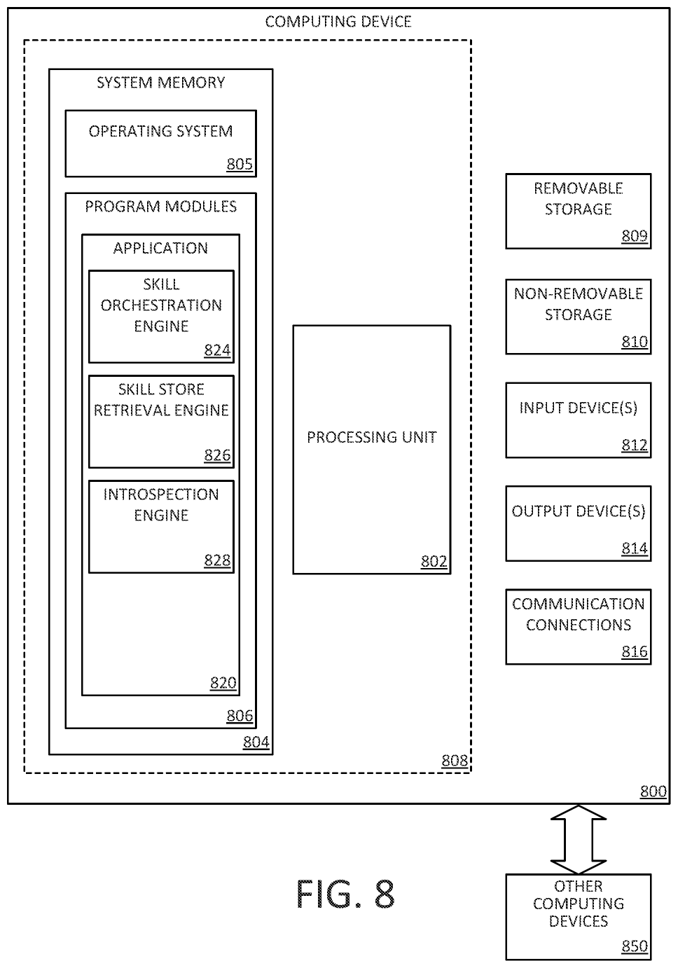

FIGS. 8-10 and the associated descriptions provide a discussion of a variety of operating environments in which aspects of the disclosure may be practiced. However, the devices and systems illustrated and discussed with respect to FIGS. 8-10 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above, including computing device 102 in FIG. 1. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for running software application 820, such as one or more components supported by the systems described herein. As examples, system memory 804 may store skill orchestration engine or component 824, skill store retrieval engine or component 826, and/or introspection engine or component 828. The operating system 805, for example, may be suitable for controlling the operation of the computing device 800.

Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

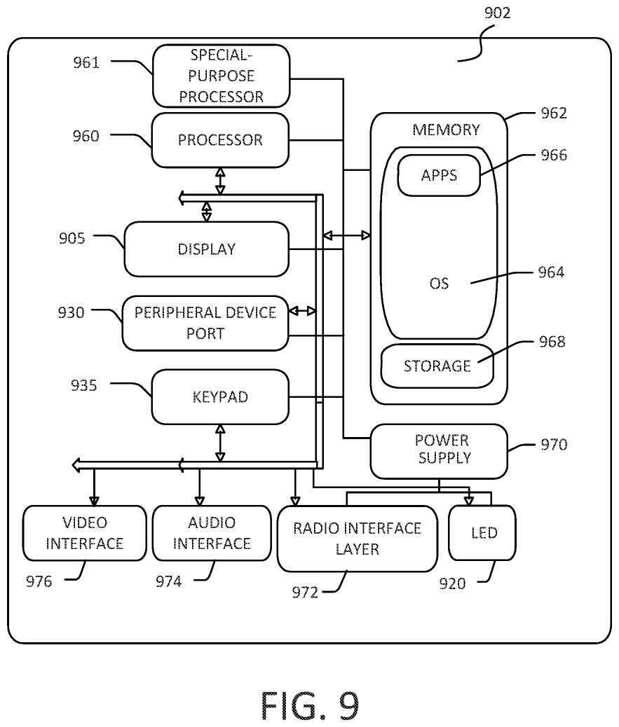

FIG. 9 is a block diagram illustrating the architecture of one aspect of a computing device. That is, the computing device can incorporate a system (e.g., an architecture) 902 to implement some aspects. In some examples, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g., an embedding object memory insertion engine, an embedding object memory retrieval engine, etc.).

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated example, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and/or special-purpose processor 961 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with aspects of the present disclosure, the microphone may also serve as an audio sensor to facilitate control of notifications, as will be described below. The system 902 may further include a video interface 976 that enables an operation of an on-board camera 930 to record still images, video stream, and the like.

A computing device implementing the system 902 may have additional features or functionality. For example, the computing device may also include additional data storage devices (removable and/or non-removable) such as, magnetic disks, optical disks, or tape. Such additional storage is illustrated in FIG. 9 by the non-volatile storage area 968.

Data/information generated or captured by the computing device and stored via the system 902 may be stored locally on the computing device, as described above, or the data may be stored on any number of storage media that may be accessed by the device via the radio interface layer 972 or via a wired connection between the computing device and a separate computing device associated with the computing device, for example, a server computer in a distributed computing network, such as the Internet. As should be appreciated such data/information may be accessed via the computing device via the radio interface layer 972 or via a distributed computing network. Similarly, such data/information may be readily transferred between computing devices for storage and use according to well-known data/information transfer and storage means, including electronic mail and collaborative data/information sharing systems.

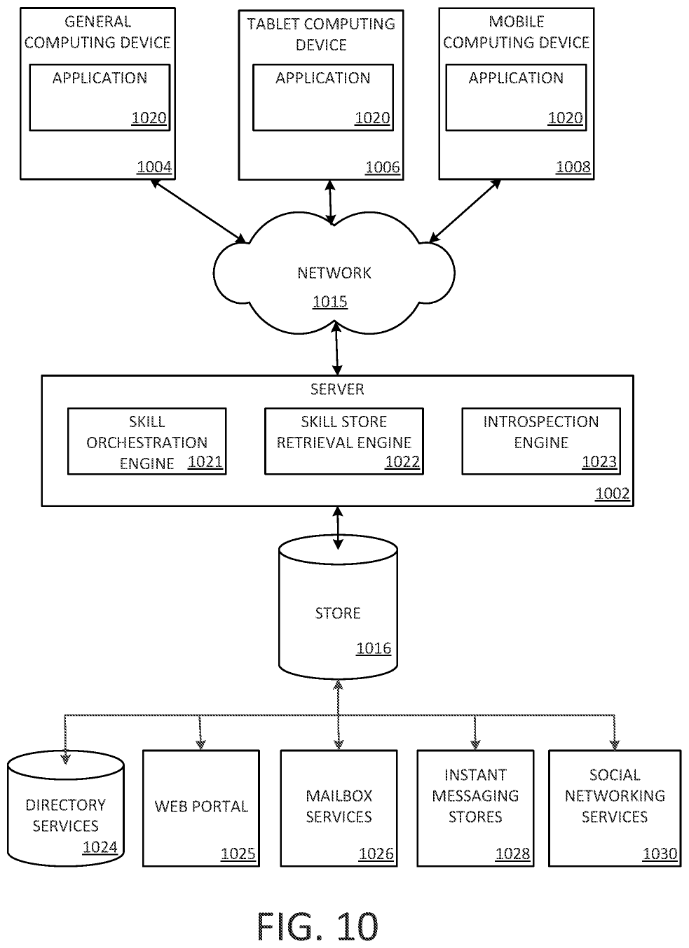

FIG. 10 illustrates one aspect of the architecture of a system for processing data received at a computing system from a remote source, such as a personal computer 1004, tablet computing device 1006, or mobile computing device 1008, as described above. Content displayed at server device 1002 may be stored in different communication channels or other storage types. For example, various documents may be stored using a directory service 1024, a web portal 1025, a mailbox service 1026, an instant messaging store 1028, or a social networking site 1030.

An application 1020 (e.g., similar to the application 820) may be employed by a client that communicates with server device 1002. Additionally, or alternatively, skill orchestration engine 1021, skill store retrieval engine 1022, and/or introspection engine 1023 may be employed by server device 1002. The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these examples of the computing devices may obtain content from the store 1016, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concepts embodied in this application that do not depart from the broader scope of the claimed disclosure.

What is claimed is:

1. A method for interfacing with a skill store, the method comprising:
processing, using a generative large model (GLM), a task to orchestrate skills for performing the task, wherein the orchestrated skills comprise a plurality skills related to the task;
determining that at least one skill in the orchestrated skills is not available to the GLM;
transmitting an indication corresponding to the at least one skill to a remote skill store;
receiving, from the remote skill store, a remote skill corresponding to the transmitted indication; and
performing the task.

2. The method of claim 1, wherein the determining that at least one skill in the orchestrated skills is not available to a GLM comprises determining that at least one skill in the orchestrated skills does not correspond to one or more local skills stored on a local device.

3. The method of claim 1, wherein the transmitting an indication corresponding to the at least one skill to a remote skill store comprises generating a description of the at least one skill; and wherein the receiving the remote skill comprises receiving the remote skill based on the description of the at least one skill.

4. The method of claim 3, wherein the receiving a remote skill comprises performing an introspection on the remote skill, based on the description, to generate a confidence threshold corresponding to the remote skill and the task.

5. The method of claim 3, wherein the description is a short description, wherein the transmitting an indication corresponding to the at least one skill to a remote skill store further comprises generating a long description of the at least one skill, and wherein the receiving the remote skill comprises receiving the remote skill based on the generated long description and the generated short description of the at least one skill.

6. The method of claim 5, wherein the generated long description and the generated short description comprise natural language or an intermediate language.

7. The method of claim 1, wherein the task is processed using the GLM, wherein the GLM uses the remote skill to perform the task.

8. The method of claim 1, wherein one or more skills of the orchestrated skills are stored on a local device, and wherein the one or more skills stored on the local device are stored in one of a public skill store or a private skill store.

9. The method of claim 1, wherein one or more of the plurality of skills comprise machine-executable instructions, and wherein the performing the task comprises:
adapting one or more devices to execute the machine-executable instructions.

10. The method of claim 1, further comprising, prior to performing the task, providing a notification to a user corresponding to the remote skill and receiving feedback from the user, in response to the notification, validating the remote skill.

11. A method for interfacing with a skill store, the method comprising:
receiving, from a local device, a parameter for a skill store, wherein the parameter is associated with a short description and long description;
receiving a subset of skills from a skill store, based on the short description, wherein the retrieving a subset of skills comprises:
determining a respective similarity between the parameter and each skill stored within the skill store, based on the short description;
comparing the one or more of the similarities to a predetermined threshold or ranking the one or more of the similarities; and
retrieving the subset of skills, based on the comparing or ranking, thereby retrieving a subsets of skills from the skill store that are determined to be related to the short description;
receiving a skill from the subset of skills, based on the long description;
returning the skill.

12. The method of claim 11, wherein the short description and the long description each comprise one of natural language data or an embedding.

13. The method of claim 11, wherein the skill store comprises one or more of a vector representation, hierarchical representation, or graph of skills stored therein.

14. The method of claim 13, wherein the skill store comprises the vector representation of skills stored therein, and wherein the vector representation is stored in at least one of an approximate nearest neighbor (ANN) tree, a k-d tree, or a multidimensional tree.

15. The method of claim 11, wherein the skill store is one of a plurality of skill stores that are segregated by tenants.

16. The method of claim 11, wherein the skill store is one a plurality of skill stores that comprises a private skill store and a public skill store.

17. The method of claim 11, wherein the skill store comprises a skill description, for one or more skills of the skills stored therein, generated by a large language model (LLM), and wherein the respective similarity is determined based at least in part on the skill description.

18. The method of claim 11, further comprising:
receiving a new skill to be stored in the skill store;
validating the new skill against a security protocol; and
updating the skill store to include the new skill.

19. The method of claim 11, wherein the predetermined threshold is a first predetermined threshold, and wherein the receiving a skill from the subset of skills, based on the long description comprises:
determining a respective similarity between the parameter and each skill of the subset of skills, based on the long description;
comparing the one or more of the similarities to a second predetermined threshold or ranking the one or more of the similarities; and
retrieving the skill, based on the comparing or ranking, thereby retrieving a skill from the subsets of skills that is determined to be related to the long description.

20. A system for interfacing with a skill store, the system comprising:
a processor; and
memory storing instructions that, when executed by the processor, cause the system to perform a set of operations, the set of operations comprising:
receiving, from a local device, a parameter for a skill store, wherein the parameter is associated with a description;
receiving a subset of skills from a skill store, based on the description, wherein the retrieving a subset of skills comprises:
determining a respective semantic similarity between the parameter and each skill stored within the skill store, based on the description;
matching the parameter to at least one skill within the skill store based on the determined semantic similarities; and
retrieving the subset of skills, based on the matching, thereby retrieving a subsets of skills from the skill store that are determined to be related to the description based on semantic similarity;
returning the subset of skills.
